(19) United States
(12) Patent Application Publication
(10) Pub. No.: US 2024/0208592 A1
(43) Pub. Date: Jun. 27, 2024

(54) AUTOMATED GUIDED VEHICLE; SYSTEM; METHOD FOR TRANSPORTING A LOAD BY MEANS OF AN AGV; METHOD FOR TRANSPORTING A LOAD BY MEANS OF A SYSTEM

(71) Applicant: Schaeffler Technologies AG & Co. KG, Herzogenaurach (DE)

(72) Inventors: Rossevelt Vicente Reyes Yazquez, Singapore (SG); Boon Siew Han, Singapore (SG); Jingyuan Tan, Singapore (SG)

(73) Assignee: Schaeffler Technologies AG & Co. KG, Herzogenaurach (DE)

(21) Appl. No.: 18/557,079

(22) PCT Filed: Apr. 26, 2021
(86) PCT No.: PCT/EP2021/060768

§ 371 Date: Oct. 25, 2023

(51) Int. Cl. B62D 33/08; B62D 33/02

(52) U.S. Cl. CPC B62D 33/08; B62D 33/02

(57) ABSTRACT

An automated guided vehicle, AGV, especially an inverted pendulum AGV, wherein the AGV includes a load-platform for carrying a load, a first leg-system connected to a first wheel, and a second leg-system connected a second wheel. The AGV includes a first rotation-motor for rotating the first leg-system around a rotation axis, and/or the AGV includes a first linear actuator for linearly extending and/or shortening at least a part of the first leg-system.

### CROSS-REFERENCE TO RELATED APPLICATIONS

This application is the U.S. National Phase of PCT Appln. No. PCT/EP2021/060768, filed Apr. 26, 2021, the entire disclosure of which is incorpo-rated by reference herein.

### TECHNICAL FIELD

The present disclosure relates to an automated guided vehicle (AGV), especially an inverted pendulum AGV, comprising a load-platform for carrying a load, a first leg-system connected to a first wheel, and a second leg-system connected a second wheel. Furthermore, the present disclosure relates to a system, comprising an AGV and a further AGV. Moreover, the present disclosure relates to a method for transporting a load by means of an AGV and a method for transporting a load by means of a system.

### BACKGROUND

The development of two wheeled inverted pendulum AGV systems has attracted increasing attention in research and development, as widespread applications for such systems for transport of goods and persons are conceivable. Moreover, such two-wheeled, self-balancing transporters are of great interest for control development.

Inverted pendulum AGVs are based on an accurately controlled vertical balance. Known AGVs of this kind have severe problems with heavy or oversized loads, since such loads can affect the robot's balance. As these AGVs typically have only two wheels and thus only points of contact, their stability polygon is a line, making stability a limiting factor such that the robots can only manage small loads with respect to their dimensions.

Therefore, known robotic configurations have severe constraints with regards to their stability and load carrying capacities which prevents their usage in a variety of different fields. In particular, systems known from the state of the art are typically constrained by the static mechanic configuration of each of their agents.

### SUMMARY

An object of the present disclosure is to provide an AGV, especially an inverted pendulum AGV, by means of which an improved and/or more flexible transportation of loads becomes possible. A further object is to provide a system by means of which an improved and/or more flexible transportation of loads becomes possible.

The object of the present disclosure is achieved by an automated guided vehicle, AGV, especially an inverted pendulum AGV, wherein the AGV comprises
a load-platform for carrying a load;
a first leg-system connected to a first wheel; and
a second leg-system connected a second wheel;
characterized
   in that the AGV comprises a first rotation-motor for rotating the first leg-system around a rotation axis, and/or
   in that the AGV comprises a first linear actuator for linearly extending and/or shortening at least a part of the first leg-system.

Thereby, according to the present disclosure an advantageous and flexible AGV may be implemented. The AGV is capable of rotating its first leg-system around a rotation axis and/or of linearly extending (i.e., lengthening) and/or shortening at least a part of its first leg-system. As such, at least the position of the first wheel may be changed relative to the position of the load-platform of the AGV. Thereby, an adjustment to different load-configurations becomes possible, whereby the usability of the AGV for transporting a payload may be improved in a variety of situations and applications. Preferably, an AGV according to the present disclosure is especially suitable for usage in a modular system of two or more AGVs, wherein the system can be used to transport payloads by means of a combined usage of the two or more AGVs. By means of the present disclosure, an advantageous solution for increasing the load hauling capacities of AGVs and/or of an inverted pendulum AGV system, comprising two or more AGVs, can be achieved. By means of the present disclosure, an improved flexibility for transporting loads with different weights and weight-distributions becomes possible such that the range of applications of AGVs is strongly enhanced.

According to an embodiment of the present disclosure, the AGV can be understood to be an agent and/or robot. Especially, the AGV according to the present disclosure may be an inverted pendulum robot.

For an inverted pendulum AGV, the payload weight on the load-platform can be balanced by a change of the velocity, especially by means of the wheels. The weight of the payload is especially balanced directly over the contact points (vertical plane).

According to an embodiment of the present disclosure, the first and second leg-systems can also be understood as limbs and/or arms of the AGV.

According to a preferred embodiment of the present disclosure,
the rotation axis, around which the first leg-system is rotatable, extends at least partly perpendicular to a main plane of the load-platform, and/or
the first linear actuator is configured for linearly extending and/or shortening at least the part of the first leg system at least partly parallel to the main plane of the load-platform. Thereby, the first leg-system can be flexibly adjusted such that the first wheel may be freely positioned.

According to a preferred embodiment of the present disclosure,
the AGV comprises a second rotation-motor for rotating the second leg-system around a rotation axis, which especially extends at least partly perpendicular to the main plane of the load-platform, and/or
the AGV comprises a second linear actuator for linearly extending and/or shortening at least a part of the second leg system, especially at least partly parallel to the main plane of the load-platform. Therein, preferably both leg-systems of the AGV can be rotated and linearly extended and/or shortened, whereby a particularly advantageous flexibility for reacting to different load situations and configurations may be achieved. It is conceivable that the first and the second rotation-motor are implemented as a single rotation-motor. As an alternative, it is possible that the first and second rotation-motors are separate rotation-motors. It is conceivable that the first and/or second rotation-motors are stepper motors.

According to a preferred embodiment of the present disclosure, the first and second rotation axes are parallel to each other and perpendicular to the main plane of the load-platform. According to a further preferred embodiment of the present disclosure, the rotation axes of the first and second leg-systems coincide such that the rotation axis of the first leg-system and the rotation axis of the second leg-system are the same axis. However, it is conceivable that the first rotation axis and the second rotation axis are different axes that are preferably parallel to each other.

According to a preferred embodiment of the present disclosure,—especially while the AGV is in operation and/or carrying a load on its load-platform—the AGV is configured such that:
the first leg-system is rotated around its rotation axis, and/or
at least the part of the first leg system is linearly lengthened or shortened, and/or
the second leg-system is rotated around its rotation axis, and/or
at least the part of the second leg system is linearly lengthened or shortened, preferably in response to a load-configuration on the load-platform, especially dependent on a spatial distribution of the load on the load-platform and/or dependent on the local amount of load on the load-platform, and/or in response to a change of the load-configuration on the load-platform. It is advantageously possible that the AGV is able to automatically adjust its leg-systems by linear extension/shortening and/or by rotation. Thereby, no mechanical adjustment by a user or operator is necessary. The reconfiguration of the first leg-system and/or second leg-system (by means of the first and/or second rotation-motor and/or the first and/or second linear actuator) may occur while the load is transferred to the load-platform and/or before the load is transferred to the load platform and/or while the load is already placed on the load-platform. It is especially conceivable that the reconfiguration of the first leg-system and/or second leg-system is done while the AGV is already carrying the load. It is especially possible that the AGV is enabled to automatically adapt the configuration of its first and/or second leg-system when a change of the load-configuration of the load (local distribution of the load on the load-platform and/or overall load on the load-platform) is detected by means of appropriate sensors.

The AGV especially comprises computer-means for configuring the first rotation-motor, second rotation-motor, first linear actuator and/or second linear actuator such that:
the first leg-system is rotated around its rotation axis, and/or
at least the part of the first leg system is linearly lengthened or shortened, and/or
the second leg-system is rotated around its rotation axis, and/or
at least the part of the second leg system is linearly lengthened or shortened,
   preferably in response to a load-configuration on the load-platform, especially dependent on a spatial distribution of the load on the load-platform and/or dependent on the local amount of load on the load-platform, and/or in response to a change of the load-configuration on the load-platform.

According to an embodiment of the present disclosure, the first leg-system and/or the second leg-system are configured such that the altitude of the AGV, especially the altitude of the load-platform, is changeable. For this purpose, it is conceivable that the first leg-system and/or the second leg-system comprise means for changing the altitude and/or height of the load-platform. It is especially possible that the first leg-system and/or the second leg-system comprise scissor legs that allow to modify the altitude of the AGV and/or the platform of the AGV. It is conceivable that the computer-means of the AGV are configured such that the altitude of the load-platform is changeable by means of the computer-means configuring the means for changing the altitude of the legs-systems. It is conceivable that the first leg-system and the second leg-system each comprise the means for changing the altitude and/or height of the load-platform. It is possible that—by means of the means for changing the altitude and/or height of the load-platform—the first and second leg-systems may be individually extended or shortened in a direction perpendicular to the main plane of the load-platform, Thereby, it is conceivable that the first wheel and/or the second wheel may be individually lifted, especially when the AGV is part of the system comprising two or more AGVs.

According to an embodiment of the present disclosure, it is preferred that the AGV is moved by means of actuators comprised in the wheels (i.e., in the first wheel and/or in the second wheel). These actuators in the wheels are especially usable for navigation and for reconfiguration.

According to an embodiment of the present disclosure, it is possible to implement an adaptive reconfiguration mechanism for the AGV that is connected to the legs (i.e., the first and/or second leg-system of the AGV).

According to a preferred embodiment of the present disclosure, the AGV comprises connecting means for connecting the AGV with a further AGV, especially reversibly, wherein the connecting means preferably comprise a magnetic connector. Preferably the connector is an electro-magnetic connector that can be activated and/or deactivated by means of the computer-means of AGV and/or by means of a central controller of the system.

Furthermore, the present disclosure relates to a system, especially a modular system, comprising an AGV according to an embodiment of the present disclosure and a further AGV according to an embodiment of the present disclosure. Therein, the further AGV especially is an AGV according to an embodiment of the present disclosure. Especially, the system comprises a plurality of AGVs, each being an AGV according to an embodiment of the present disclosure.

Thereby, an advantageous modular system for carrying a load may be formed by means of at least two, preferably a plurality of, AGVs. The AGVs of the system are configured such that the respective positions of their wheels with respect to their load-platforms are adjustable. Thereby, for the combined system of at least two (or more) AGVs the wheel positions of each individual AGV may be changed to achieve an advantageous and stable configuration of wheel-positions for the overall system.

According to a preferred embodiment of the present disclosure,
the AGV comprises connecting means for connecting the AGV with the further AGV, especially reversibly, and/or
the further AGV comprises connecting means for connecting the further AGV with the AGV, especially reversibly, wherein the connecting means of the AGV and/or the connecting means of the further AGV especially comprise magnetic connectors. It is conceivable that the connecting means of the AGV and the further AGV are complementary connecting means such that the AGV and the further AGV are connectable by means of the connecting means of the AGV and the further AGV. It is especially preferred according to an embodiment of the present disclosure that the connecting means of the AGV and the further AGV comprise magnetic, especially electro-magnetic, connectors. In case the system comprises a plurality of AGVs, it is particularly preferred that each of the AGVs comprises corresponding connecting means such that the plurality of AGVs is connectable to form a combined system, preferably with a combined platform. Therein, an advantageous modular system of interconnected AGVs may be realized.

According to a preferred embodiment of the present disclosure,
especially while the system is in operation and/or while the AGVs of the system are collectively carrying a load on their load-platforms—in response to a load-configuration on the load-platforms of the AGV and/or the further AGV and/or in response to a change of a load-configuration on the load-platforms of the AGV and/or the further AGV,
   the AGV and the further AGV are configured such that their respective first leg-systems and/or second leg-systems are adjusted, especially adjusted such that:
the first leg-system of the AGV is rotated around its rotation axis, and/or
the part of the first leg-system of the AGV is linearly lengthened or shortened, and/or
the second leg-system of the AGV is rotated around its rotation axis, and/or
the part of the second leg-system of the AGV is linearly lengthened or shortened, and/or such that:
the first leg-system of the further AGV is rotated around its rotation axis, and/or
the part of the first leg-system of the further AGV is linearly lengthened or shortened, and/or
the second leg-system of the further AGV is rotated around its rotation axis, and/or
the part of the second leg-system of the further AGV is linearly lengthened or shortened. Preferably, the AGV and the further AGV comprise computer-means, e.g., controllers, processors, etc., for configuring their respective first rotation-motor, second rotation-motor, first linear actuator and/or second linear actuator such that such that they are adjusted.

Thereby it is advantageously possible that the respective positions of the first and/or second wheel of the AGV and/or the respective positions of the first and/or second wheel of the further AGV relative to the load-platforms are changed in response to a load-configuration on the load-platforms of the AGV and the further AGV and/or in response to a change of a load-configuration on the load-platforms of the AGV and the further AGV. It is especially conceivable that the load-configuration on the load-platforms relates to a spatial distribution of the load on the load-platforms and/or to the local amount and/or total amount of load on the load-platforms of the AGV and/or the further AGV. Thus, it is possible that AGV and the further AGV are configured such that their respective first leg-systems and/or second leg-systems are adjusted in response to the current spatial distribution of the load on the load-platforms of the AGV and the further AGV and/or in response to the current local amount of a load on the load-platforms and/or in response to the current total amount of load on the load-platforms.

According to a preferred embodiment of the present disclosure, the load-configuration is a detected load-configuration, wherein the detected load-configuration is especially detectable by means of a load-sensor. The load-sensor may be part of the AGV and/or the further AGV. It is possible that both the AGV and the further AGV comprise load-sensors. The load-sensors may be any type of sensors that are suitable for detecting a load or a load-configuration, e.g., mass sensors.

According to a preferred embodiment of the present disclosure, the AGV and the further AGV are configured such that their respective first leg-systems and/or second leg-systems are adjusted in response to the load-configuration on the platforms of the AGV and the further AGV such that the positions of the first wheels and/or second wheels of the AGV and further AGV are adjusted in dependence of the load-configuration. Thereby, a load polygon formed by imaginary lines that interconnect the wheels of the AGV and the further AGV (or the wheels of all AGVs of the system, in case the system comprises multiple AGVs) is adjusted in response to the load-configuration. The AGVs of the system are preferably able to reshape by rotating and/or extending and/or shortening their limbs, i.e., their respective leg-systems. According to a particularly advantageous embodiment, especially for systems comprising multiple AGVS, the position of each AGV's leg-systems can be changed to maximize the area of the stability polygon for the whole system. The reconfiguration process can be done automatically and adaptively when the system is carrying a load by means or computer-means. In case of a load weight being shifted over the platforms of the combined AGV-system or in case of the shape and/or size of the load being changed mid-task (especially during operation and/or transportation of the load), the system is capable of dynamically reconfiguring the leg-systems of one, some or all AGVs that form the system to always maintain a proper stability.

According to an embodiment of the present disclosure, a modular system, especially based on inverted pendulum robots, may be implemented that is capable of auto-reconfiguring its shape and/or kinematic configuration in order to adapt to the payload needs. It is especially possible according to an embodiment of the present disclosure hat all AGVs of the system are two-wheeled inverted pendulum balancing robots with mechanically elastic scissor legs connected to their wheels. It is preferred that each of the AGVs has a shape reconfiguration mechanism, especially connected to the center of its load-platform. According to an embodiment of the present disclosure, the reconfiguration mechanism of each AGV preferably comprises a first rotation-motor for rotating the first leg-system, a second rotation-motor for rotating the second leg-system, a first linear actuator for linearly extending and/or shortening at least a part of the first leg-system and a second linear actuator for linearly extending and/or shorting at least a part of the second leg-system. This mechanism is used to shift the position of the legs (or leg-systems) of an AGV around the entire footprint. It is especially preferred that this reconfiguration method is only applied when an AGV is connected to one or more further AGVs for stability purposes. Preferably, the reconfiguration mechanism or at least part thereof is placed at the center of the AGV and is mechanically connected to both legs. At the center of the mechanism, a rotation-motor (or two rotation-motors) may be located. The rotation-motor(s) rotate each leg independently around the load-platform area. The beams, connecting this mechanism to the legs, preferably each have a linear actuator that can extend and contract the legs individually. Thus, it is possible that the legs and/or wheels can be placed at any point under the load-platform. It is particularly preferred, that each wheel contains a wheel hub motor for translation, i.e., for moving the AGV.

It is especially possible according to an embodiment of the present disclosure that each of the AGV-modules is capable of an independent movement and navigation based on a central agent task scheduler and handler. Thus, an individual AGV can be used for comparably small transportation tasks below or up to its capacities. For tasks that demand the hauling of very large or very heavy payloads the individual AGVs can come together and can be connected to act as a single system. If the system of two or more connected AGVs is in a connected state, i.e., when the AGVs are connected to form a combined system, the contact points (legs) of the AGVs can be shifted around to different positions according to the nature of the payload that is placed or to be placed on the load-platforms of the AGVs, using the reconfiguration mechanism of each AGV. This allows the modular system to enlarge or retract is stability polygon according to the size of the load and/or to create irregular shaped stability polygons for payloads with unevenly distributed weight-points. This configuration mechanism allows the reshaping of the robots to be automatic. Thus, no mechanical adjustment by a human operator is needed. As such, it is advantageously that the reshaping of the AGVs or the combined system of AGVs is part of the systems autonomous capabilities.

It is a particular advantage of a system according to an embodiment of the present disclosure that the system is enabled to reconfigure the position of the wheels of one, some or all of the AGVs while the system of AGVs is carrying a payload, especially in the case that the payload elements and/or weight shift during transportation. The multi-modular system (e.g., one, some or all AGVs of the system) can detect the stability shift and adapt its points of contact to the ground, especially by repositioning its wheels, accordingly.

The present disclosure further relates to a method for transporting a load by means of an AGV according to an embodiment of the present disclosure, wherein the load is placed on the load-platform of the AGV, wherein the AGV transports the load from a first place to a second place. As such, a load (or payload) is transported by means of an AGV according to the present disclosure. The “first place” may, e.g., relate to any starting point of the transport and the “second place” may, e.g., relate to any destination point of the transport.

The present disclosure further relates to a method for transporting a load by means of a system according to an embodiment of the present disclosure, wherein the load is placed on the load-platforms of the AGVs of the system, especially at least the load load-platforms of the AGV and the further AGV, wherein the AGVs of the system collectively transport the load from a first place to a second place. As such, a load (or payload) is transported by means of at least an AGV and further AGV (or more AGVs) according to the present disclosure. The “first place” may, e.g., relate to any starting point of the transport and the “second place” may, e.g., relate to any destination point of the transport.

According to a preferred embodiment of the present disclosure, especially the method, during the transport of the load from the first place to the second place
the first leg-system of the AGV and/or the second leg-system of the AGV is moved relative to the load-platform of the AGV by means of the first rotation-motor, second rotation-motor, first linear actuator and/or second linear actuator of the AGV, and/or
the first leg-system of the further AGV and/or the second leg-system of the further AGV is moved relative to the load-platform of the further AGV by means of the first rotation-motor, second rotation-motor, first linear actuator and/or second linear actuator of the further AGV. Thereby, an improved adaption during the transport is possible. Thereby, an improved stability may be achieved and failures and accidents may be reduced.

According to a preferred embodiment of the present disclosure, especially the method, the movement of the first leg-system of the AGV and/or the second leg-system of the AGV and/or the movement of the first leg-system of the further AGV and/or the second leg-system of the further AGV is performed
in response to detecting a load-configuration on the load-platforms of the AGV and/or the further AGV and/or
in response to detecting a change of load-configuration on the load-platforms of the AGV and/or the further AGV.

### BRIEF DESCRIPTION OF THE DRAWINGS

These and other characteristics, features and advantages of the present disclosure will become apparent from the following detailed description, taken in conjunction with the accompanying drawings, which illustrate, by way of example, the principles of the disclosure. The description is given for the sake of example only, without limiting the scope of the disclosure. The reference figures quoted below refer to the attached drawings.

FIGS. 1 and 2 schematically illustrate a front-view and a side-view of an AGV according to an embodiment of the present disclosure.

FIG. 3 schematically illustrates an AGV according to an embodiment of the present disclosure.

FIG. 4 schematically illustrates a part of an AGV according to an embodiment of the present disclosure.

FIG. 5 schematically illustrates a caster mechanism of an AGV according to an embodiment of the present disclosure.

FIGS. 6a, 6b, 6c and 6d schematically illustrate an AGV according to an embodiment of the present disclosure with different positions of the leg-systems and wheels.

FIG. 7 schematically illustrates an AGV according to an embodiment of the present disclosure, wherein load-platforms of different sizes are shown.

FIG. 8 schematically illustrates possible position of a leg-system of an AGV according to an embodiment of the present disclosure.

FIG. 9 schematically illustrates a system of robots with a fixed and static stability polygon.

FIG. 10 schematically illustrates a modular system, comprising multiple AGVs, according to an embodiment of the present disclosure.

FIG. 11 schematically illustrates a modular system, comprising multiple AGVs, according to an embodiment of the present disclosure.

### DETAILED DESCRIPTION

The present disclosure will be described with respect to particular embodiments and with reference to certain drawings but the disclosure is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the disclosure described herein are capable of operation in other sequences than described or illustrated herein.

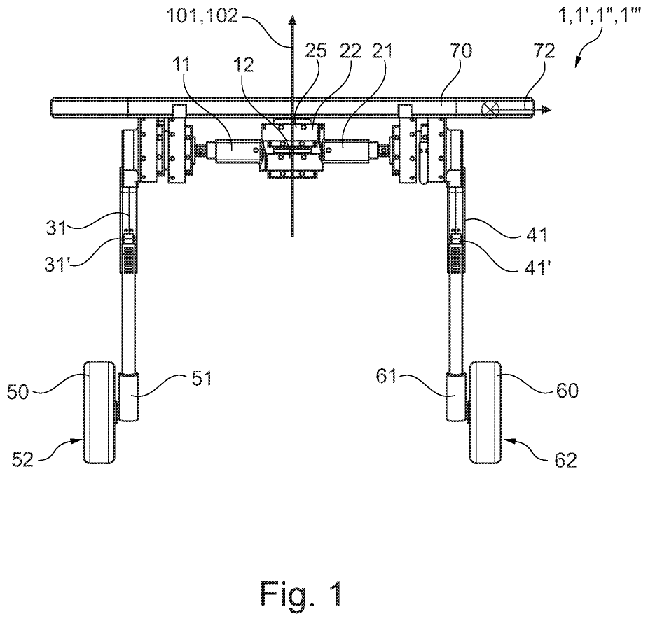

In FIG. 1, an inverted pendulum automated guided vehicle 1, 1′, 1″, 1′″, AGV, according to an embodiment of the present disclosure is schematically illustrated in a front-view. The AGV 1 includes computer-means, e.g., a controller, for controlling the different functions of the AGV. The AGV 1 comprises a load-platform 70, e.g., a plate portion, which comprises or is connected to connecting means 91, especially magnetic connectors 92, for connecting the AGV 1 to one or more further AGVs. The AGV 1 comprises a base 25 which is attached to or fixed on the lower side of the load-platform 70. It is conceivable that the connection between the base 25 and the load-platform 70 is reversible, such that the base 25 (and thus the leg-systems 31, and 41 and the wheels 50, 60) can be connected to different load-platforms 70, 70′, 70″. Preferably the base 25 is connected to a center of the load-platform 70. The AGV 1 comprises a first leg-system 31 and a second leg-system 41, each of which has a first part and a second part, wherein the first part extends from the base 25 in a direction substantially parallel to a main plane 72 of the load-platform 70, and wherein the second part extends from a tip portion of the first part in a direction away from the load-platform 70. Furthermore, a first wheel 50 is rotationally connected to a tip of the second part of the first leg-system 31 and a second wheel 60 is rotationally connected to a tip of the second part of the second leg-system 41.

The first leg-system 31 comprises a first linear actuator 11 for extending and/or shortening the first part of the first leg-system 31 in a direction parallel to the main plane 72 of the load-platform 70. Furthermore, preferably as part of the base 25, the AGV 1 comprises a first rotation-motor 12 for rotating the first leg-system 31 around a rotation axis 101, which extends perpendicular to the main plane 72 of the load-platform 70. The second leg-system 41 comprises a second linear actuator 21 for extending and/or shortening the first part of the second leg-system 41 in a direction parallel to the main plane 72 of the load-platform 70. Furthermore, preferably as part of the base 25, the AGV 1 comprises a second rotation-motor 22 for rotating the second leg-system 41 around a rotation axis 102, which extends perpendicular to the main plane 72 of the load-platform 70. The first and second rotation-motors 12, 22 are especially built as stepper motors. The first and second rotation-motors 12, 22 are located on the lower side of the load-platform 70, especially in the center of the load-platform 70. In the shown embodiment, the rotation axes 101, 102 coincide and form a single rotation axis 101, 102. The rotation-motors 12, 22 as well as the linear actuators 11, 21 of both leg-systems 31, 41 are controlled by means of the computer-means of the AGV 1, especially by means of the controller of the AGV 1. The rotation-motors 12, 22 and the linear actuators 11, 21 form a reconfiguration mechanism of the AGV 1 that allows a flexible and advantageous reconfiguration of the position of the leg-systems 31, 41, especially during operation. Both, the first leg-system 31 and the second leg-system 41 are formed by means of scissor-legs. Therein, the leg-systems 31, 41 both comprise a joint 31′, 41′. The height of the load-platform 70, i.e., the distance of the load-platform 70 to the ground, can be changed by means of the leg-systems 31, 41, especially by means of the scissor legs and/or the joints 31′, 41′. Furthermore, the first wheel 50 comprises or is connected to a first wheel actuator 52 and the second wheel 60 comprises or is connected to a second wheel actuator 62. The AGV 1 is moved by means of the wheel actuators 52, 62. The wheel actuators 52, 62 are used for navigation and for reconfiguration.

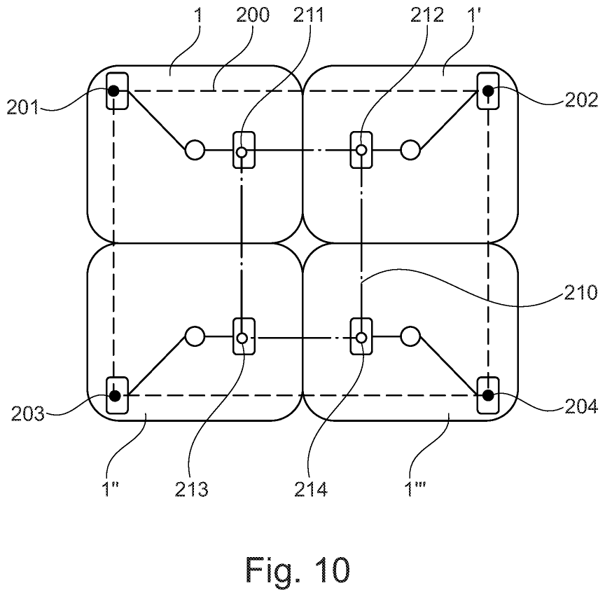

A first caster mechanism 51 is connected to the first wheel 50 and a second caster mechanism 61 is connected to the second wheel 60. The caster mechanisms 51, 61 comprise active caster joints that are connected to the wheels 50, 60 such that an automated direction change during the usage of a the AGV 1, especially as part of a system comprising multiple AGVs 1, 1′, 1″, 1′″, becomes possible. The caster mechanisms 51, 61, especially the caster joints, also allow omnidirectional motion for the AGV 1, 1′, 1″, 1′″. Especially, it is conceivable that for each of the AGVs 1, 1′, 1″, 1′″ of a system according to an embodiment of the present disclosure (e.g., FIG. 10), an active caster joint is connected to the first wheel 50 of each AGV 1, 1′, 1″, 1′″ and an active caster joint is connected to the second wheel 60 of each AGV 1, 1′, 1″, 1′″.

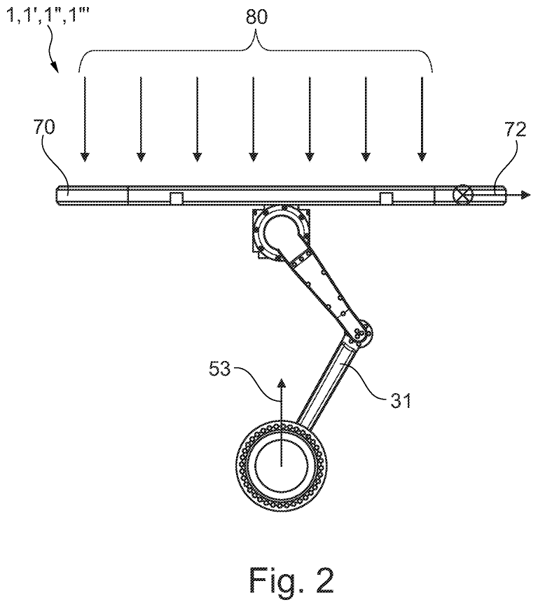

In FIG. 2, a side-view of the AGV 1, 1′, 1″, 1′″ according to the embodiment of FIG. 1 is shown. A load 80 that may be carried by the AGV 1 is symbolized by the arrows 80. The weight of the load 80 on the load-platform 70 can be balanced by a change of velocity of the wheels 50, 60. The weight of the load 80 is balanced directly over the contact points/balance points (vertical plane 53).

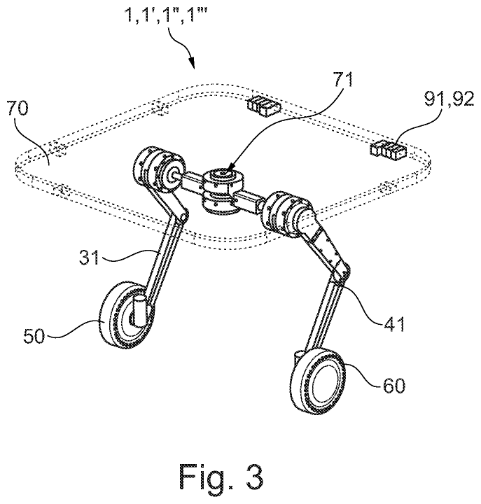

In FIG. 3, the AGV 1 according to the embodiment of FIGS. 1 and 2 is schematically illustrated in a perspective view. The connecting means 91, especially magnetic connectors 92, for connecting the AGV 1 to one or more further AGVs are shown. Preferably the connecting means 91 may be activated and/or deactivated by means of the computer-means of the AGV 1 for reversibly connecting (and/or disconnecting) the AGV 1 to one or more further AGVs. The connecting means 90 may be formed as electromagnetic latches that are used to connect and fasten two or more AGVs 1, 1′, 1″, 1′″ to achieve a swarm behavior. These electromagnetic latches are magnetized when voltage is supplied by means of the computer-means of the AGV 1 (e.g., a central controller). The contact joint 71 of the base 25 and/o leg-systems 31, 41 with the load-platform 71 is located in the center of the load-platform 70.

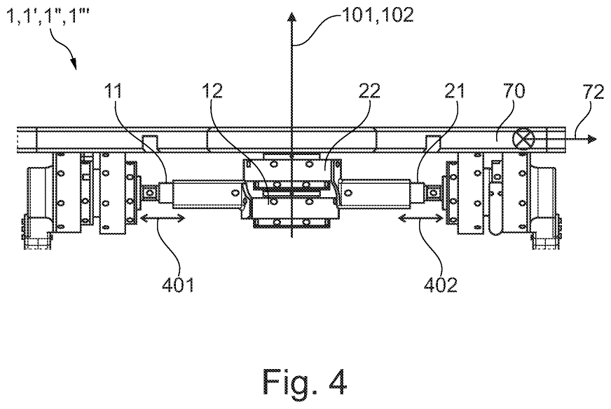

In FIG. 4, a part of the AGV 1 according to the embodiment of FIGS. 1 to 3 is schematically illustrated. The extension/shortening of the first part of the first leg system 31 by means of the first linear actuator 11 and the extension/shortening of the first part of the second leg-system 41 by means of the second linear actuator 11 is symbolized by the horizontal arrows 401, 402.

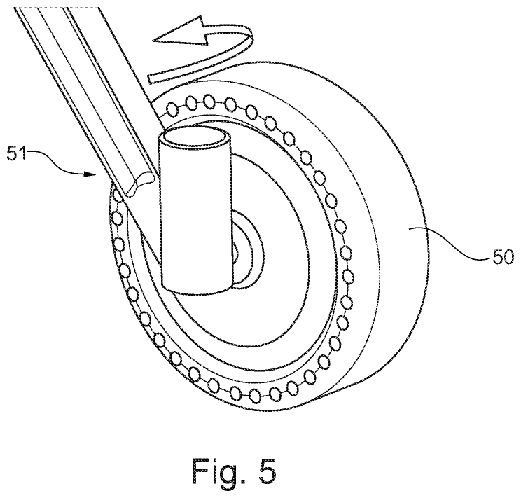

In FIG. 5, a first wheel 50 with a caster mechanism 51 of an AGV 1 according to an embodiment of the present disclosure is schematically illustrated. The second wheel 60 and its caster mechanism 61 may be built accordingly.

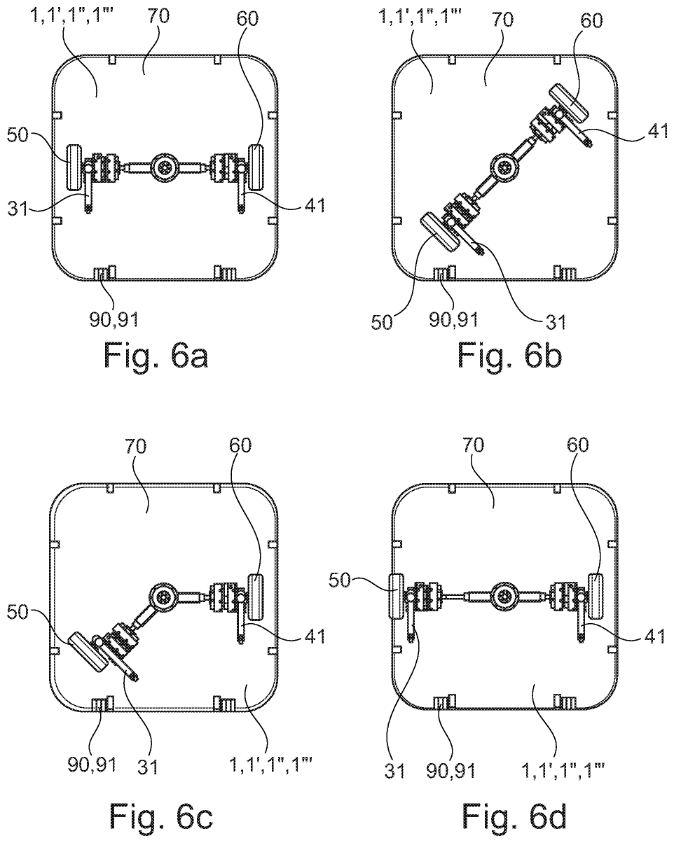

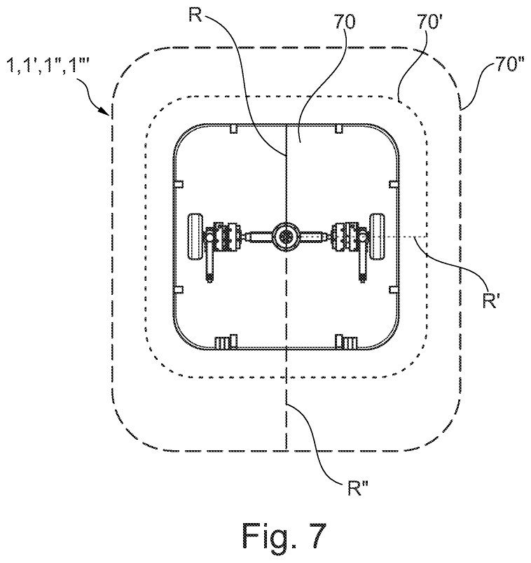

In FIGS. 6a, 6b, 6c and 6d an AGV 1 according to an embodiment of the present disclosure is schematically illustrated with different positions for the leg-systems 31, 41 and wheels 50, 60. By means of the rotation-motors 12, 12, the first leg-system 31 and second leg-system 41 may be rotated independent from each other (FIGS. 6a, 6b and 6c). As an example, a default position of the leg-systems 31, 41 is shown in FIG. 6a. Such a default position may, for instance, be useful for performing standard tasks. As shown in FIG. 6b, both leg-systems 31, 41 can be rotated in unity to change the facing direction of the load-platform 70, e.g., in applications comprising target tracking, scanning, etc. As shown in FIG. 6c, each leg-system 31, 41 can be rotated independently to be positioned according to a set of discrete angles. By means of the first linear actuator 11 and the second linear actuator 21, the first wheel 50 and the second wheel 60 can be moved outward and/or inward. As an example, FIG. 6d displays a situation, wherein the first part of the first leg-system 31 has been extended by means of the first linear actuator 11 such that the first wheel 50 is positioned further away from the center of the load-platform 70 than the second wheel 60. Each leg-system 31, 41 can be linearly shifted independent from each other and repositioned to a set of discrete positions under the platform. For a single AGV 1, 1′, 1″, 1′″, the repositioning of the leg-systems is particularly useful for carrying unevenly balanced loads 80 (in terms of shape or weight) by means of a single AGV 1, 1′, 1″, 1′″.

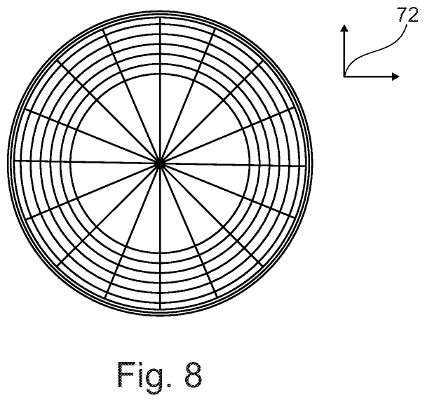

It is possible that the rotational re-localization of the leg-systems 31, 41 by means of the rotation-motors 12, 22 and the linear re-localization by means of the linear actuators 11, 21 are done simultaneously. Preferably, the positioning envelope for each leg-system 31, 41 and/or wheel 50, 60 is defined by the shape of the load-platform 70. This mechanism creates a discrete set of positions available to the leg-systems 31, 41 as shown in FIG. 8.

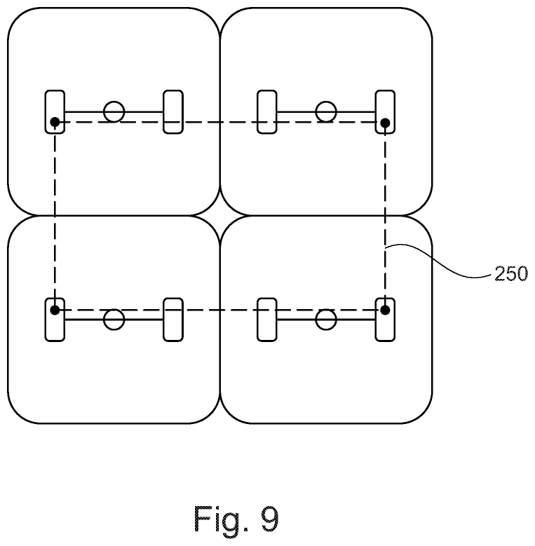

In FIG. 9 different load-platforms 70, 70′, 70″ with different sizes R, R′, R″ for an AGV 1 are shown. Preferably, the radius of the displacement available to the leg-systems 31, 41 depends on the size of the load-platform (as shown in FIG. 9), as it is critical to maintain the contact points under the load-platform 70. This mechanism also allows each AGV 1, 1′, 1″, 1′″ to be able to carry different load-platform 70, 70′, 70″ with different sizes and/or shapes without requiring to make mechanical changes to the AGV 1, 1′, 1″, 1′″. Different sizes R, R′, R″ of the load-platforms 70, 70′, 70″ can be compensated by the mechanism, comprising the rotation-motors 12, 22 and linear actuators 11, 21, automatically. As such, it is possible to implement an advantageous AGV 1, 1′, 1″, 1′″ with a replaceable load-platform 70, wherein load-platforms 70, 70′, 70″ of different sizes R, R′, R″ may be used with a single AGV 1, 1′, 1″, 1′″.

In FIG. 9, a system with multiple robots is shown. The robots have straight legs that connect the payload-platform to the wheels. This puts severe constraints on the maneuverability. When connecting this kind of robots in a modular setting, the system becomes a kind of a four, six, eight, etc. wheeled rolling platform. This means that the stability polygon 250 of the system has a static rectangular shape, such that severe issues and problems for large payloads or payloads with weight points that are unevenly distributed remain. Such a static rectangular shape of a stability polygon 250 is shown in FIG. 9 as an example. Therefore, the use of such inverted pendulum AGVs with fixed straight legs that cannot be rotated or linearly extended as a modular system would fail to improve the limiting factors of each of the individual AGVs while also hindering the versatility of the movement that each AGV module has on its own.

Such disadvantages (as explained with respect to FIG. 9) may be overcome by means of the present disclosure by implementing an improved maneuverability by means of using AGVs 1, 1′, 1″, 1′″ with improved and flexible leg-systems 31, 41, comprising rotation-motors 12, 22 and/or linear actuators 11, 21. A modular system, comprising four AGVs 1, 1′, 1″, 1′″ according to an embodiment of the present disclosure that overcomes the before mentioned deficiencies is shown in FIG. 10. By means of the system, an advantageous solution for increasing the load hauling capacities of an AGV system, especially an inverted pendulum AGV system, can be achieved. In particular, an improved flexibility for transporting loads 80 of different weight and weight-distribution becomes possible, such that the range of applications of AGVs is strongly enhanced. According to the present disclosure (and by means of using AGVSs 1, 1′, 1″, 1′″ according to embodiments of the present disclosure) an advantageous automatic adaptability of the stability polygon 200, 210 of a system comprising two or more AGVs 1, 1′, 1″, 1′″ may be achieved. The stability polygons 200, 210 can be interpreted as polygons that arise from connecting the contact points 201, 202, 203, 204, 211, 212, 213, 214 (i.e., the first wheels 50 and/or second wheels 60) by means of imaginary lines. In FIG. 10 an example is shown, wherein an inner stability polygon 210, formed by means of the contact points 211, 212, 213, 214, and an outer stability polygon 200, formed by means of the contact points 201, 202, 203, 204, are sketched. The adaptive reconfiguration system allows to reshape the stability polygons 200, 210 of the multi-agent system in real time depending on the shape of the system, the distribution of the load points on the platforms 70 and/or the size and shape of the load 80. Advantageously, it is possible that system calculates the ideal positioning of the wheels/leg-systems with respect to these needs and shifts the wheels/leg-systems automatically without the need for human intervention. The system may provide a maximum stability by enlarging and/or reshaping the outer and inner stability polygons 200, 210 as needed. As such, by combining two or more AGVs 1, 1′, 1″, 1′″ according to the present disclosure in a modular system, a particularly improved and flexible system for carrying loads 80 becomes possible. Preferably, computer means of the AGVs and/or an external controller are configured such that the altitude of the load-platforms 70 and/or the pose of the leg-systems 31, 41 of each AGV 1, 1′, 1″, 1′″ may be configured (or re-configured) based on at least the number and shape configuration of the connected AGVs and/or the weight and/or position of the load 80 on the load-platforms 70 of the AGVs 1, 1′, 1″, 1′″.

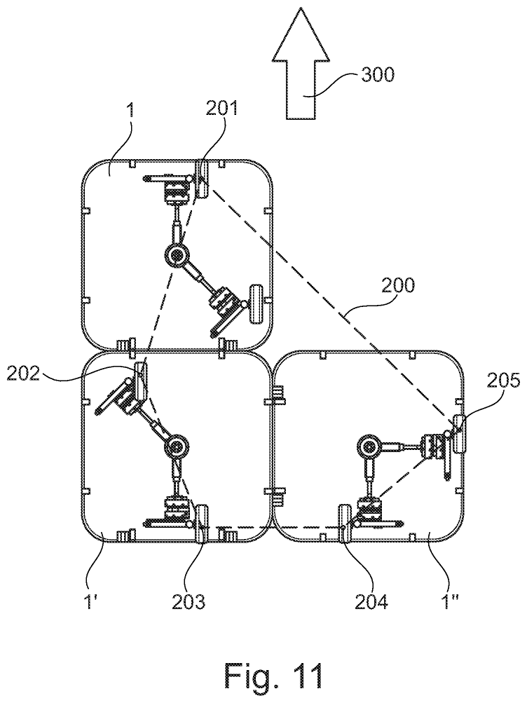

It is possible that a system according to an embodiment of the present disclosure can generate non-regular shaped stability polygons 200, 210, especially stability polygons 200, 210 that are not rectangular. It is especially possible that the shape and geometry of the stability polygon can be freely adjusted by means of the reconfiguration mechanisms, comprising the leg-systems 31, 41, especially rotation-motors 12, 22 and/or linear actuators 11, 21, of the AGVs 1, 1′, 1″, 1′″ of the combined system. Such a system allows the creation of multi-agent platforms of complex shapes for a myriad of applications. An example according to an embodiment of the present disclosure is shown in FIG. 11, wherein the system comprises three AGVs 1, 1′, 1″. The leg-systems 31, 41 of the AGVs 1′, 1″, 1′″ are positioned such that the contact points 201, 202, 203, 204, 205 form the stability polygon 200. The direction of movement 300 of the system of AGVs 1, 1′, 1″ is indicated by the arrow 300. The dynamical reconfiguration system will create the stability polygon shape necessary to provide the highest stability to the system based on the loads and the configuration of the multi-modular system. The system also ensures that the wheel actuators 52, 62 are rotating always in the same direction, providing torque towards the general movement. Each wheel comprises or is connected to an active caster wheel which allows the multi-modular system to swiftly change directions omnidirectionally without the need for disassembly.

### REFERENCE SIGNS

1 AGV
1′ further AGV
1″, 1′″ further AGV
11 first linear actuator
12 first rotation-motor
21 second linear actuator
22 second rotation-motor
25 base
31 first leg-system
31′ joint
41 second leg-system
41′ joint
50 first wheel
51 first caster mechanism
52 first wheel actuator
53 vertical plane
60 second wheel
61 second caster mechanism
62 second wheel actuator
70 load-platform
70′ load-platform
70″ load-platform
71 joint of the leg-systems and the load-platform
72 main plane
80 load
91 connecting means
92 magnetic connector
101 rotation axis
102 rotation axis
200 stability polygon
201, 202, 203, 204, 205 contact points
210 inner stability polygon
211, 212, 213, 214 contact points
250 stability polygon with a static rectangular shape
300 direction of movement
401 linear extension/shortening
402 linear extension/shortening
R size of the load platform
R′ size of the load platform
R″ size of the load platform

1. An automated guided vehicle (AGV) comprising:
a load-platform for carrying a load;
a first leg-system connected to a first wheel; and
a second leg-system connected to a second wheel;
wherein the AGV includes at least one of a first rotation-motor for rotating the first leg-system around a first rotation axis or a first linear actuator for linearly extending or shortening at least a part of the first leg-system.

2. The automated guided vehicle (AGV) according to claim 1,
wherein the first rotation axis, around which the first leg-system is rotatable, extends at least partly perpendicular to a main plane of the load-platform, and
wherein the first linear actuator is configured for linearly extending or shortening at least the part of the first leg system at least partly parallel to the main plane of the load-platform.

3. The automated guided vehicle (AGV) according claim 2,
wherein the AGV comprises at least one of a second rotation-motor for rotating the second leg-system around a second rotation axis, extending at least partly perpendicular to the main plane of the load-platform, or
a second linear actuator for linearly extending or shortening at least a part of the second leg system at least partly parallel to the main plane of the load-platform.

4. The automated guided vehicle (AGV) according to claim 3, wherein while the AGV is in operation and carrying a load on the load-platform, the AGV is configured such that at least one of:
the first leg-system is rotated around the first rotation axis or at least the part of the first leg system is linearly lengthened or shortened, or
the second leg-system is rotated around the second rotation axis, or
at least the part of the second leg system is linearly lengthened or shortened in response to
a load-configuration on the load-platform.

5. A system comprising:
an automated guided vehicle and a further automated guided vehicle, each automated guided vehicle (AGV) including:
a load-platform for carrying a load;
a first leg-system connected to a first wheel; and
a second leg-system connected to a second wheel;
wherein the AGV includes at least one of a first rotation motor for rotating the first leg-system around a first rotation axis or a first linear actuator for linearly extending or shortening at least a part of the first leg-system.

6. The system according to claim 5, wherein at least one of the AGV or further AGV includes connecting means for connecting to another of the AGV or further AGV.

7. The system according to one claim 5, wherein during operation, while the AGVs of the system are collectively carrying a load on their load-platforms, in response to a load-configuration on the load-platforms of at least one of the or the further AGV or in response to a change of a load-configuration on the load-platforms of the AGV or the further AGV,
the AGV and the further AGV are configured such that their respective first leg-systems or second leg-systems are adjusted, wherein:
the first leg-system of the is rotated around its rotation axis,
or the part of the first leg-system of the AGV is linearly lengthened or shortened,
or the second leg-system of the AGV is rotated around its rotation axis,
or the part of the second leg-system of the AGV is linearly lengthened or shortened;
or:
the first leg-system of the further AGV is rotated around its rotation axis,
or the part of the first leg-system of the further AGV is linearly lengthened or shortened, or
the second leg-system of the further AGV is rotated around its rotation axis,
or the part of the second leg-system of the further AGV is linearly lengthened or shortened.

8. The system according to claim 7, wherein the load-configuration is a detected load-configuration, wherein the detected load-configuration is detected by a load-sensor.

9. The system according to claim 7, wherein the AGV and the further AGV are configured such that their respective first leg-systems or second leg-systems are adjusted in response to the load-configuration on the platforms of the AGV and the further AGV such that positions of the first wheels or second wheels of the AGV and further AGV are adjusted in dependence of the load-configuration.

10. (canceled)

11. A method for transporting a load comprising:
providing a system including an automated guided vehicle and a further automated guided vehicle, each automated guided vehicle (AGV) including:
a load-platform for carrying a load;
a first leg-system connected to a first wheel; and
a second leg-system connected to a second wheel;
wherein the AGV includes at least one of a first rotation motor for rotating the first leg-system around a first rotation axis or a first linear actuator for linearly extending or shortening at least a part of the first leg-system
wherein the load is placed on the load-platforms of the AGV of the system, especially at least the load load-platforms of the AGV and the further AGV,
wherein the AGVs of the system collectively transport the load from a first place to a second place.

12. The method according to claim 11, wherein during the transport of the load from the first place to the second place
at least one of the first leg-system of the AGV or the second leg-system of the AGV is moved relative to the load-platform of the AGV by the first rotation-motor, second rotation-motor, first linear actuator or second linear actuator of the AGV,
or at least one of the first leg-system of the further AGV or the second leg-system of the further AGV is moved relative to the load-platform of the further AGV by the first rotation-motor, second rotation-motor, first linear actuator or second linear actuator of the further AGV.

13. The method according to claim 12, wherein the movement of the first leg-system of the AGV or the second leg-system of the AGV or the movement of the first leg-system of the further AGV or the second leg-system of the further AGV is performed
in response to detecting a load-configuration on the load-platforms of at least one of the AGV or the further AGV or
in response to detecting a change of load-configuration on the load-platforms of the AGV or the further AGV.
